(19) United States
(12) Patent Application Publication
(10) Pub. No.: US 2006/0224484 A1
(43) Pub. Date: Oct. 5, 2006

(54) System and method of economic taxation

(76) Inventors: Eli Nhaissi, Old Westbury, NY (US); Oren Nhaissi, Old Westbury, NY (US)

Correspondence Address: Dennis M. Flaherty, Esq.;Ostrager Chong Flaherty & Broitman P.C., Suite 825, 250 Park Avenue, New York, NY, 10177-0899, US

(21) Appl. No.: 11/098,641

(22) Filed: Apr. 4, 2005

(51) Int. Cl. G06Q 40/00

(52) U.S. Cl. 705/35

(57) ABSTRACT

A method of taxation comprising the following steps: changing consumption tax rates at short intervals of time; applying the consumption tax rate in effect to every taxable transaction that occurs during that short interval of time; setting progressive income tax rates to be in effect for a long interval of time; and applying the progressive tax rate in effect to all taxpayer yearly incomes equal to or greater than a predetermined progressive tax minimum income. Taxpayers who file a statement declaring yearly income less than a consumption tax minimum income will receive a refund of consumption taxes paid; while those who file a statement declaring yearly income equal to or greater than the consumption tax minimum income, but less than the progressive tax minimum income, will receive a rebate or credit for consumption taxes that is regressive. Surplus consumption tax revenue is held in a buffer reserve and later used during intervals of time during which a shortfall in consumption tax revenue has occurred.

### BACKGROUND OF THE INVENTION

The present invention generally relates to systems and methods for economic taxation. In particular, the invention relates to an economic taxation system for providing a perpetual healthy and steady economic growth and at the same time minimizing the economic cycle, including inflation and deflation, in developed countries.

The industrialized developed countries use different tax methods to finance their budgets. One tax method is a combination of a progressive tax rate based on yearly income and other taxes based on the sale of finished consumer products or services. A tax of the latter type is applied in the U.S.A. when consumer products are sold and is called a sales tax. A different tax of the same type is applied in many other countries when products or services are sold to consumers and is called a value added tax (VAT). The above tax systems have been developed aggressively in the last 200 years and their first priority is to finance the budget.

During the past 200 years, the U.S.A. has suffered almost 40 economic crises, on average one every five years. Some of these crises were more severe than others, but most of them were very costly to the nation's GNP. There is a need for a system of taxation that could be employed to damp the severity of the economic cycle.

Even though much was accomplished in the last few decades to measure the performance of the modem economy, still the economy is lacking better economic measures that, with on-line data, could be used to fine tune economic performance on a continuous bases. There is a need to create healthy and steady economic growth with insignificant economic interruption that is partially caused by the economic cycle, while reducing significantly the inflation and deflation concern.

Today the economy lacks a mechanism for applying a continuous dynamic stimulus while monitoring and improving upon the existing economic stabilizers. Furthermore the present tax system allows excessive tax avoidance in every taxpayer income bracket. The present tax system is unable to collect tax from the subterranean economy that is estimated to be 16% of the GNP or about 1.9 trillion dollars with potential tax collection of about 300 billion dollars, or almost 15% of the present tax collection of the U.S. government. This present tax system does not motivate taxpayers to report all their yearly income, in addition to being too complicated for the ordinary taxpayer.

On the other hand, it can be seen that monetary policy in the developed countries is very satisfactory and the central banks are doing an excellent job in avoiding inflation and deflation. Furthermore, the fiscal policy of developed countries under the circumstances is very well managed in order to satisfy the social material need as well as to avoid deflation and inflation. However, in the last two decades many changes have occurred: the service sector of the U.S. economy and other developed countries has increased dramatically; the consumer sector has became the dominant factor in the U.S. economy; and new technology is very quickly dominating the U.S. economy and way of life. This new technology is so advanced, especially new cheap powerful computers, that there is a continuously increasing gap between social progress and technological progress. The reason for this circumstance is that technology is advancing so fast. However, although the economy is producing cheap and huge computer power, that computing power is not being used to properly advance the prosperity of each country's economy.

### BRIEF DESCRIPTION OF THE INVENTION

The present invention is directed to a method and a system for applying a variable consumption tax, in conjunction with a progressive income tax, to the economy of a country.

One aspect of the invention is a method of taxation comprising the following steps: changing consumption tax rates at short intervals of time; applying the consumption tax rate in effect during any given short interval of time to every taxable transaction that occurs during that short interval of time; setting progressive income tax rates to be in effect for a long interval of time; and applying the progressive tax rate in effect during the long interval of time to all taxpayer yearly incomes equal to or greater than a predetermined progressive tax minimum income, wherein the short intervals of time occur during the long interval of time.

Another aspect of the invention is a system for taxing the economy of a country, comprising: multiplicities of transaction computers distributed over a geographical area, each of the transaction computers being programmed to apply a consumption tax rate to every taxable transaction; and a taxation computer system programmed to determine consumption tax rates and disseminate those consumption tax rates to the multiplicities of transaction computers at short intervals of time, wherein each of the transaction computers is further programmed to report data representing the consumption tax revenue from each taxable transaction to the taxation computer system.

Other aspects of the invention are disclosed and claimed below.

### BRIEF DESCRIPTION OF THE DRAWINGS

FIG. 1 is a block diagram representing a distributed computer network for use in applying a variable consumption tax to a national economy in accordance with one embodiment of the invention.

FIG. 2 is a flowchart showing the flow of tax receipts in accordance with one embodiment of the invention.

Reference will now be made to the drawings in which similar elements in different drawings bear the same reference numerals.

### DETAILED DESCRIPTION OF THE INVENTION

According to the broad aspect of the invention, a tax system is provided in order to create a perpetual steady and healthy economic growth and minimize the fluctuations of the economic cycle, simultaneously enabling the government to raise the funds to meet its budgetary goal. The proposed system uses a combination of progressive income tax to be applied to all yearly income above a certain level and variable consumption tax to be applied periodically, e.g., monthly or biweekly. The variable consumption tax will be applied to goods and services, excluding certain exemptions.

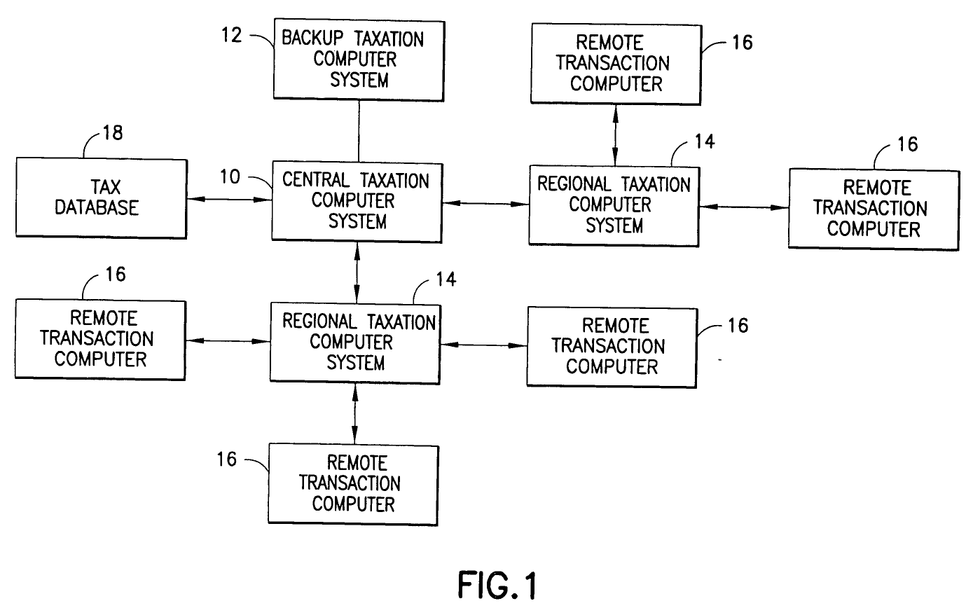

In accordance with one embodiment of the invention, the consumption tax is applied throughout the economy using a nationwide computer network. One possible implementation of such a computer network is generally depicted in FIG. 1. In accordance with this implementation, the consumption tax rates for each time period (and optionally for each economic sector) are computed at a central taxation computer system 10, which may comprise a single computer with huge computing power or multiple interconnected computers having individual computing powers the sum of which is equally huge. The central taxation computer system 10, which is operated by a competent governmental taxation or revenue department, computes the consumption tax rates in accordance with an economic analysis that considers many factors (described in more detail later).

Once the consumption tax rates have been determined, the central taxation computer system 10 disseminates those rates electronically to a multiplicity of regional taxation computer systems 14, each being situated in a respective region, state or province inside the particular country. The central taxation computer system 10 may communicate with the regional taxation computer systems 14 via a wide area network, dedicated lines, or any other suitable conventional means of computer intercommunication. Again each regional taxation computer system 14 may comprise a single computer or multiple interconnected computers and is operated by the governing tax or revenue department.

Each regional taxation computer system 14 in turn disseminates the consumption tax rate or rates electronically to a respective multiplicity of remote transaction computers 16 located at every remote site within the respective region where business subject to the consumption tax is transacted. Each transaction computer 16 at a remote site would be identified by a system identification number and would be categorized in accordance with the type of business being transacted at the remote site. For example, each system identification number may have a sector category number associated with it that indicates what sector of the economy (e.g., automotive, electronics, aviation, hotels, home construction) the business being transacted at the remote site belongs to.

Each remote transaction computer 16 may be privately owned except for consumption tax software owned by or licensed to the government, which consumption tax software may be downloaded by each business proprietor free of charge from a government-maintained website. Preferably, the regional taxation computer systems are programmed to download the current consumption tax rates to the remote transaction computers automatically, e.g., during hours when the businesses are closed, without requiring any initiative or action by the business proprietors. Preferably the communications are encrypted and cannot be tampered with. Each remote transaction computer may be provided with security software that rejects any attempt to load the computer with consumption tax rates unless the incoming transmission contains encrypted security data that indicates the authenticity of the source of the transmission.

To facilitate the transaction of business, the government may issue a scannable taxpayer identification card to every taxpayer. At a minimum, that card would have the taxpayer's identification code encoded thereon. To complete each transaction, the consumer must produce his taxpayer identification card for scanning into the remote transaction computer. If a family member (e.g., souse or child) buys products or services but has no yearly income, that person may be provided with a taxpayer identification card that has the same taxpayer identification code as that of the family's income earner.

After each transaction with a consumer during business hours or at regular time intervals, each remote transaction computer 16 automatically sends the data for each transaction to its corresponding regional taxation computer system 14. That transaction data includes the taxpayer identification number of the person who paid consumption tax, the amount of consumption tax paid, the time and date of the transaction, the remote computer system identification number and other pertinent information. The transaction data from the remote computers 16 can be stored in the memory of the regional taxation computer systems 14 or in databases (not shown in FIG. 1) associated therewith. This information is regularly uploaded to the central taxation computer system 10, which stores the transaction data from all regions in a tax database 18. Preferably, a backup taxation computer system 12 (located at a site remote from the site of the central taxation computer system 10) is provided to take over for the central taxation computer system 10 in the event that the latter crashes, is shut down for maintenance, or is otherwise disabled. Each regional taxation computer system 14 is also preferably provided with a respective backup computer system (not shown in FIG. 1).

The implementation shown in FIG. 1 allows the consumption tax revenue to be measured on-line by a central authority using a widely distributed computer network. Therefore the government will record most of such tax every minute and the tax will be paid daily by the collector or vendor through automatic electronic transfer.

As previously mentioned, on a periodic basis or on an as-needed basis, each remote computer receives updated information concerning the consumption tax rate to be applied in the upcoming time period. The consumption tax rate will be adjusted up or down periodically based on many economic and other factors. Some of the factors that can be considered include the following: minimizing the economic cycle; steady and healthy economic growth; budgetary needs and goals; progressive income tax receipts; other tax receipts; fiscal policy; monetary policy, social policy; welfare policy; environmental issues; demographic structural changes; technological factors; weather and natural disasters; world economic stability; military defense needs; changes in national social, political and legislative policies; labor; the availability of natural and human resources; inflation or deflation rate; rate of unemployment; consumer confidence; business spending; local currency stability; and international trade and balance of payments. A computer of the central taxation computer system 10 is programmed to compute the variable consumption tax rates based on some or all of the foregoing factors, which factors must be represented by the input of current values reflecting the state of each factor.

In accordance with a further aspect of the invention, different consumption tax rates can be set for different economic sectors. In that case, the government-operated consumption taxation computers will periodically disseminate the respective adjusted consumption tax rates to the remote computers for all economic sectors.

In accordance with one embodiment of the invention, all citizens and residents of a nation or state will file a tax return and declare their yearly income to the governmental taxation or revenue department. However, only persons having a yearly income equal to or greater than a first predetermined amount (e.g., $200,000) will be subject to payment of the progressive income tax. The yearly income amount at which taxpayers will begin to pay progressive income tax will be referred to herein as the Progressive Tax Minimum Income (PTMI). If a person filing a tax return has yearly income less than the PTMI, then that person will not be subject to the progressive income tax and need not itemize any deductions available under the tax code.

Furthermore, only persons having a yearly income equal to or greater than a second predetermined amount, referred to herein as the Consumption Tax Minimum Income (CTMI), will be subject to payment of the variable consumption tax. The yearly income amount at which taxpayers will begin to pay consumption tax will be less than the PTMI, e.g., $35,000. If a person filing a tax return can prove that he or she had an amount of yearly income less than the CTMI, then that person will receive a consumption tax rebate from the government equal in amount to the amount of consumption tax paid during the relevant time period. In the case of the implementation previously described, in which all transaction data, including taxpayer identification number and consumption tax paid, is automatically sent to the central taxation computer system operated by the government, then the consumption tax rebates could be processed automatically by the government based only the tax information already in its possession upon entry into the computer database of information showing that the taxpayer had yearly income less than the CTMI.

Alternatively, a system could be implemented wherein the governmental computer system receives for each transaction the amount of consumption tax paid, but due to privacy and security concerns, does not receive the taxpayer identification number from the remote computer. In the latter case, a person having yearly income below the CTMI can submit proof of the amount of consumption tax paid during the relevant time period and will then receive from the government a refund for that amount of consumption tax paid.

An arrangement can be made whereby tourists pay consumption tax at the time of each purchase and later claim a refund of all consumption taxes paid. A procedure can be instituted whereby the names, passport numbers and nationalities of tourists passing through customs are registered in a tourist consumption tax refund database and the tourist is issued a tourist identification card for use in making transactions. The vendor will scan the tourist identification card into the remote transaction computer instead of a taxpayer identification card at the time of each purchase. All consumption taxes paid by tourists in this way will be automatically uploaded to the central taxation computer system and stored in the tourist consumption tax refund database. If a tourist during his/her stay pays consumption tax in excess of a minimum threshold, after that tourist departs and returns to his own country, he/she can submit an application for a refund of all consumption taxes paid in excess of the minimum threshold. The refund application must include the passport number of the person making the request so that the correct amount of paid consumption taxes can be determined from the tourist consumption tax refund database. The refund can be wired to the tourist's bank overseas.

In accordance with one embodiment of the invention, persons having yearly incomes equal to or in excess of the CTMI, but less than the PTMI, will be obliged to pay consumption tax on all products and services that they purchase, excluding items not subject to the consumption tax, but no progressive income tax. As previously noted, persons, having yearly incomes less than the CTMI will be entitled to a refund of all consumption taxes paid, i.e., will pay no consumption tax. Persons having yearly incomes greater than the PTMI will pay consumption tax on all products and services that they purchase, excluding items not subject to the consumption tax, and will also pay progressive income tax.

Alternatively, in accordance with a variation of the foregoing embodiment, persons having yearly incomes equal to or in excess of the CTMI, but less than the PTMI, will pay a progressive consumption tax. Stated another way, such taxpayers will receive a regressive rebate, i.e., a rebate that decreases with increasing yearly income, for consumption taxes paid. For example, for the yearly income range from $35,000 (CMTI) to $200,000 (PMTI), a multiplicity of income brackets could be provided, each next higher income bracket receiving a consumption tax rebate that is a smaller percentage than that received by the next lower income bracket.

A simple example might be instructive. Assume that the consumption tax rate is 17%. Persons with yearly income less than the CMIT ($35,000 in this example) would be entitled to a full rebate. In this example, persons with yearly income in the range of $35,000 to $50,000 would be entitled to an almost full rebate such that their effective consumption tax rate is 1%; persons with yearly income in the range of $50,001 to $60,000 would be entitled to a slightly smaller rebate such that their effective consumption tax rate is 2%; persons with yearly income in the range of $60,001 to $70,000 would be entitled to a slightly smaller rebate such that their effective consumption tax rate is 3%; and so forth until persons with yearly income in the range of $190,001 to $200,000 would be entitled to a very small rebate such that their effective consumption tax rate is 16%. Persons with yearly income greater than the PTMI (in this example, $200,000) would pay the full 17% consumption tax. Others schemes for providing a regressive consumption tax rebate could be readily designed.

In some cases, it may not be possible to transact business electronically, in which case a consumer may demand a receipt for consumption tax paid from a vendor. When a consumer demands a receipt for consumption tax paid from a vendor or, in the case of electronic transactions, when the consumption tax paid is registered automatically in a taxation computer, that will make the vendor show all his sales without hiding any portion.

Consequently, the fact that the consumer gets back all or part of the consumption tax paid (the proportion being a direct function of income level) from the taxation or revenue department of the government will create the following motivations: (a) the consumer will request a full registration of the consumption tax paid with the vendor; (b) the consumer will be motivated to show his full earned yearly income up to the PTMI; and (c) the vendor has no choice but to show the full sale, since it is also registered with a taxation computer and thus the vendor will show his true revenue. Therefore the disclosed method of rebate taxation will motivate consumers to show their true level of yearly income and force vendors to show their true level of revenue.

This method will also contribute significantly to accurate measurement of a country's gross national product since it will reduce the underground economy dramatically. Furthermore, this method will facilitate tax collection on line on a daily basis, and will also allow the daily total product and services within each sector of the national economy to be measured everyday. Such a method of consumption taxation will have many far-reaching benefits to a society. This method will contribute to a stable monetary policy with smaller fluctuations in interest rates. It not only creates better economic stability, but also increases consumer confidence and improves psychological well-being, and improves the social and political stability of a country. Once such goals are achieved, the developed countries could increase their contributions to assist the less privileged citizens in their own countries and especially increase their contributions to the less developed countries where such help is greatly needed.

The consumption tax schemes disclosed herein are based on the premise that other types of taxation, such as corporate taxes, capital gains taxes and estate taxes, and existing important deductions, such as interest on home mortgages, will remain in effect substantially unchanged, but such taxes, whether continued or discontinued, form no part of the present invention. In the case of business entities such as corporations and partnerships, either they will pay no consumption tax at the point of sale or they will receive a full rebate for all consumption taxes paid, in order to prevent double taxation.

To minimize dislocations in the present system of taxing the economy, the transition to the variable consumption tax scheme disclosed herein can be undertaken gradually, meaning initially the consumption tax rates can be set at low levels while the progressive income tax rates for medium- and low-income taxpayers are phased out of existence.

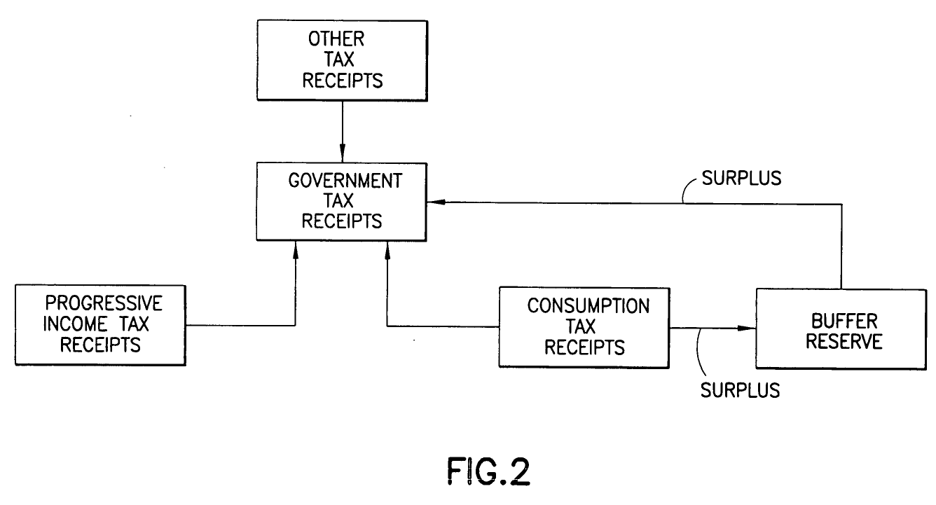

In conjunction with the adoption of a variable consumption tax, a continuously variable buffer reserve may be established from the consumption tax collection whenever governmental revenue exceeds governmental expenses. As shown in FIG. 2, consumption tax receipts in excess of the level needed by the government (i.e., surplus) are deposited in the buffer reserve. Conversely, when consumption tax receipts fall short of the level needed, then the monies in the buffer reserve are used to make up for the shortfall.

The invention assumes that the legislative branch has granted to the executive branch the authority to fix the consumption tax rate changes during short time intervals. The legislative branch may further provide guidelines to the executive branch regarding the allowable percentage change in the variable consumption tax rates, as well as giving the executive branch the authority to build or to use the variable buffer reserve. Thus, the executive branch will have the necessary powers to orchestrate the economy to achieve the goals of minimizing the fluctuations in the economic cycle, providing steady and healthy economic growth, and meeting budgetary goals.

While the invention has been described with reference to certain embodiments, it will be understood by those skilled in the art that various changes may be made and equivalents may be substituted for members thereof without departing from the scope of the invention. In addition, many modifications may be made to adapt a particular situation to the teachings of the invention without departing from the essential scope thereof. Therefore it is intended that the invention not be limited to the particular embodiment disclosed as the best mode contemplated for carrying out this invention, but that the invention will include all embodiments falling within the scope of the appended claims.

As used in the claims, the term “computer system” means one or more computers. Multiple computers of a computer system are able to communicate via a network, via dedicated lines or via any other suitable known communication means.

1. A method of taxation comprising the following steps:
changing consumption tax rates up or down at short intervals of time;
applying the consumption tax rate in effect during any given short interval of time to every taxable transaction that occurs during that short interval of time;
setting progressive income tax rates to be in effect for a long interval of time; and
applying the progressive tax rate in effect during said long interval of time to all taxpayer yearly incomes equal to or greater than a predetermined progressive tax minimum income,
wherein said short intervals of time occur during said long interval of time.

2. The method as recited in claim 1, further comprising the step of reporting the consumption tax revenue derived from every taxable transaction at a remote site to a regional or central location.

3. The method as recited in claim 1, wherein for a given short interval of time, different consumption tax rates are adopted for taxable transactions occurring within different sectors of the economy.

4. The method as recited in claim 1, wherein surplus consumption tax revenue is held in a buffer reserve and later used during intervals of time during which a shortfall in consumption tax revenue has occurred.

5. The method as recited in claim 1, wherein taxpayers who file a statement declaring yearly income less than said progressive tax minimum income do not pay progressive income tax.

6. The method as recited in claim 5, wherein taxpayers who file a statement declaring yearly income less than a consumption tax minimum income will receive a refund of consumption taxes paid, said consumption tax minimum income being less than said progressive tax minimum income.

7. The method as recited in claim 6, wherein all taxpayers who file a statement declaring yearly income equal to or greater than a consumption tax minimum income, but less than said progressive tax minimum income, will receive a rebate or credit for consumption taxes that is regressive, meaning that the effective consumption tax rate increases with increasing yearly income.

8. A system for taxing the economy of a country, comprising:
multiplicities of transaction computers distributed over a geographical area, each of said transaction computers being programmed to apply a consumption tax rate to every taxable transaction; and
a taxation computer system programmed to determine consumption tax rates and disseminate those consumption tax rates to said multiplicities of transaction computers at short intervals of time,
wherein each of said transaction computers is further programmed to report data representing the consumption tax revenue from each taxable transaction to said taxation computer system.

9. The system as recited in claim 8, wherein said taxation computer system comprises a central taxation computer system and a multiplicity of regional taxation computer systems, said central taxation computer system determining said consumption tax rates and disseminating said consumption tax rates to said regional taxation computer systems, and each of said regional taxation computer systems disseminating said consumption tax rates to a respective multiplicity of transaction computers located in a respective region of said geographical area.

10. The system as recited in claim 9, wherein the transaction computers of each region report their respective consumption tax revenue data to a corresponding regional taxation computer system, and all of said regional taxation computer systems report consumption tax revenue data received from a respective multiplicity of transaction computers to said central taxation computer system.
